(19) United States
(12) Patent Application Publication
(10) Pub. No.: US 2011/0127730 A1
(43) Pub. Date: Jun. 2, 2011

(54) SEAL CONFIGURATION FOR THE MOTOR VEHICLE FRONT WALL

(75) Inventors: Artem SERYI, Wiesbaden (DE); Holger SCHENK, Wiesbaden (DE)

(73) Assignee: GM GLOBAL TECHNOLOGY OPERATIONS, INC., Detroit, MI (US)

(21) Appl. No.: 12/954,182

(22) Filed: Nov. 24, 2010

(30) Foreign Application Priority Data
Nov. 27, 2009 (DE) 102009056043.2

(51) Int. Cl. F16L 5/02

(52) U.S. Cl. 277/606

(57) ABSTRACT

A seal configuration is provided for sealing an opening of a motor vehicle front wall provided for the passage of heating and/or air-conditioning pipes, such as heating and/or air-conditioning pipes, having a two-component seal body insertable into the opening, which has an outer peripheral edge component made of a first seal material and an inner seal component made of a second seal material. The first and the second seal materials have different moduli of elasticity and/or different acoustic damping properties.

### CROSS-REFERENCE TO RELATED APPLICATION

This application claims priority to German Patent Application No. 102009056043.2, filed Nov. 27, 2009, which is incorporated herein by reference in its entirety.

### TECHNICAL FIELD

The technical field relates to a seal configuration for sealing an opening of a motor vehicle front wall, which is provided for the passage of heating and/or air-conditioning pipes.

### BACKGROUND

For the desired temperature control of the passenger compartment of a motor vehicle, it is necessary to lead fluid-conducting pipelines from the engine compartment of a motor vehicle into the passenger compartment, so that, for example, water heated via the waste heat of an internal combustion engine can be supplied to a heating element situated inside the passenger compartment, typically an air-water heat exchanger. Conditions are similar with air-conditioning lines, via which vaporizers of an air-conditioning system situated inside the passenger compartment are connected to the remaining components of a coolant circuit. The passage of these pipes through the vehicle front wall or bulkhead requires a seal, in particular to protect the vehicle interior against moisture or other penetrating dirt particles.

Diverse seals are known in the prior art. Typical seals are completely formed, for example, from polyurethane foam (PUR), which has comparatively good noise-damping properties and is sufficiently compressible in particular for the installation of the seal on the front wall opening. However, polyurethane foam is disadvantageous with respect to its elasticity for such seals, for example, if the position of the pipe in the area of the front wall opening to be sealed varies within certain tolerance boundaries.

PUR-based seal elements are typically subject to a permanent and lasting deformation. Therefore, they can only provide inadequate compensation for component and installation tolerances and for component movements. Other seal solutions provide a seal body made of rubber, for example, made of ethylene-propylene-diene rubber (EPDM). EPDM does have increased elasticity in comparison to PUR foam. Thus, possible component and installation tolerances may be compensated for using an EPDM seal, but also component movements occurring in continuing operation of the motor vehicle, extensively without impairment of the seal function. However, EPDM is hardly compressible in comparison to PUR foam and requires a separate installation solution upon the attachment of the seal to the front wall opening.

Furthermore, for example, a two-part pipe seal element is known from DE 10 2007 005 371 A, which has a seal made of urethane and a soundproof rubber web. However, the seal and the rubber web are situated axially offset to one another viewed in the axial direction of the pipe. In addition, this pipe seal element does not offer axial fixing of the pipe in relation to the partition wall. The seal is fixedly connected to the pipe in this case using a press fit, which presses the seal against the partition wall while standing under bias tension.

In view of the foregoing, it is at least one object to provide a front wall seal for heating or air-conditioning pipes, which is improved with respect to tightness and noise insulation, and which is additionally particularly simple and cost-effective to produce and also can be installed using only few installation steps on the pipe to be sealed and/or on the vehicle front wall. In addition, other objects, desirable features and characteristics will become apparent from the subsequent summary and detailed description, and the appended claims, taken in conjunction with the accompanying drawings and this background.

### SUMMARY

A seal configuration is provided in accordance with an embodiment that has a two-component seal body, which is insertable into the opening of the motor vehicle front wall to be sealed. The seal body has an outer peripheral seal component made of a first seal material and an inner seal component made of a second seal material First and second seal materials differ with respect to their modulus of elasticity and/or with respect to their acoustic damping properties. A seal body exploits the respective advantages of known seal materials while extensively remedying their respective disadvantages.

It is thus particularly provided according to an embodiment that the peripheral edge component has a deformability which is advantageous for installation purposes on the vehicle front wall opening, and which allows simple installation of the seal body, for example, without the aid of tools, on the front wall. The inner seal component preferably has a higher elastic deformability than the outer seal component, so that possible position and installation tolerances and also movements of the pipes to be sealed in relation to the front wall may be compensated for extensively without impairment of the tightness.

Furthermore, the installation of the seal in the area of the front wall or bulkhead passage is made easier by the prefinished two-component seal body. This is because only a single seal body is to be provided in an installation aspect, which may be provided ready for installation, preassembled by a motor vehicle supplier.

The outer peripheral seal component advantageously has improved acoustic and/or mechanical damping properties in comparison to the inner seal component. In this way, a transmission of structure-borne noise between the vehicle front wall and the heating pipes can be damped.

According to a first embodiment, it is provided that the inner seal component is completely enclosed by the outer seal component with respect to the extension in the radial direction of a pipe to be led through the front wall opening, i.e., in the plane perpendicular to the pipe extension, which is essentially coincident with the plane of the motor vehicle front wall, the inner seal component is completely encompassed by the outer seal component. Furthermore, in this way the inner seal component can be extensively mechanically and/or acoustically decoupled from the front wall.

According to another embodiment, all of the passage openings for the heating and/or air conditioning pipes are provided in the inner seal component. This is much better suitable for forming a seal which is at least liquid-tight, if not even gas-tight, for the pipes to be led through the motor vehicle front wall, due to its higher elasticity in comparison to the outer seal component

According to a further embodiment, the outer and the inner seal components are essentially in a common plane. This plane is preferably coincident with the plane of the motor vehicle front wall in the area of its passage opening. The pipe passage through the seal body can be produced essentially perpendicularly, but also diagonally to the plane of the seal body. The inner seal component is provided with at least one, preferably multiple passage openings for the pipes to be led through the vehicle front wall. Adjoining the passage openings, the inner seal component preferably has a peripheral seal flange section. In this way, a sealing surface between the pipe and the inner seal component can be enlarged, which results in an improved sealing action. The sealing flange section can be formed essentially cylindrically or also conically tapering toward its free end, for example. The sealing flange section of the inner seal component at least sectionally has an at least slightly smaller internal diameter than the external diameter of the heating or air conditioning pipe to be led through. The elasticity of the inner seal component is further selected in such a way that a sufficient seal function is already achieved by leading the pipe through the passage opening. The seal itself can also be fixed on the respective pipe by the elastic deformation of its seal components and the clamping action accompanying it.

According to another embodiment, it is further provided that at least the inner seal component is at least regionally implemented like folded bellows in the area of its passage openings, i.e., the seal component has a corrugated shape radially adjoining the passage openings to the outside, which allows a displacement of the pipe in the plane of the seal component. In this way, possible position or component tolerances of the respective heating or air conditioning pipe may be compensated for extensively without impairment of the sealing function. Furthermore, in this way a certain mobility of the heating or air-conditioning pipes can be provided in operation of the vehicle, without this occurring at the cost of the functional reliability of the seal.

According to a further embodiment, it is further provided that the inner seal component is connected via a folded bellows to the outer seal component. Furthermore, a position and tolerance compensation of all pipe passage openings provided in the inner seal component in relation to the front wall opening can be provided via this connection, which is like a folded bellows, of inner and outer seal components. The embodiment like a folded bellows is preferably integrated completely in the inner seal component. Through the implementation like a folded bellows at least two times on the edge of the inner seal component and on the edges of the passage openings implemented therein, all passage openings of the inner seal component can be implemented as displaceable both jointly in relation to the opening of the motor vehicle front wall and also to one another in a tolerance-compensating way.

According to another embodiment, the inner seal component is manufactured from a natural or synthetic rubber material, in particular from ethylene-propylene-diene rubber (EPDM). EPDM has a ductility of up to 500% and remains permanently elastic even under long-lasting usage over a wide temperature range. Using the inner seal component, which is manufactured from EPDM, a fixation of the pipes, which compensates for positions and tolerances and also provides an outstanding seal, can be achieved in relation to the motor vehicle front wall. The disadvantages of an EPDM seal component existing with respect to the acoustic behavior may be extensively compensated for and canceled out by the outer seal component, which is manufactured according to a further preferred embodiment of the invention from foamed plastic or artificial resin, in particular from polyurethane. The outer seal component is particularly formed from a permanently elastic soft foam, in particular a PUR foam, which allows simple and reliable as well as permanent installation of the seal body on the front wall opening. The acoustic damping properties of the seal body may also be improved using the attachment on the front wall side occurring via the PUR seal component.

According to a further embodiment, the outer and the inner seal components are connected to one another in a formfitting and/or materially-bonded manner. In particular vulcanization or hot-air welding of the inner EPDM component with the outer PUR component comes into consideration here as the joining method. The inner and the outer seal components may also have formfitting means corresponding to one another in their attachment area, using which the two seal components are to be at least provisionally connected to one another during the manufacturing of the seal body.

Furthermore, it is conceivable to produce the two-component seal body using a two-component injection molding method, one of the two components being injected or foamed onto the respective other component in particular.

Furthermore, according to another embodiment, the seal body can be fastenable via its outer seal component in a friction-locked manner in the opening of the motor vehicle front wall. The outer seal component can particularly have a fastening bead, using which it can be engaged with an edge of the motor vehicle front wall opening formed corresponding thereto, while forming a form fit. Furthermore, connecting the outer seal component and thus the entire seal body to the motor vehicle front wall via a press fit or clamp fit is additionally conceivable.

A further embodiment of the seal having an advantageous design is achieved in that the inner seal component has a trough-like depression for fastening and/or accommodating an expansion valve of an air-conditioning system. A pot-like or trough-like depression of the inner seal component allows the accommodation of an expansion valve, which is already fastened on the pipe to be led through the seal component, on the one hand.

On the other hand, via the trough-like depression, the seal component can already be situated in a twist-locked manner on the corresponding pipeline of the air-conditioning or heating unit of the motor vehicle before installation on the vehicle front wall. The accommodation of the expansion valve in the seal also offers axial fixation of the seal with respect to the pipe before it is fastened at the location provided for this purpose in the motor vehicle.

Finally, it can further be provided that the passage openings of the seal body provided for the air-conditioning lines are situated in the area of a base of the trough-like depression of the inner seal component. The seal configuration can essentially comprise the seal body, but can also, depending on the embodiment, comprise still further components, such as individual additional seal elements, such as seal rings, as well as possible fastening components (not shown in greater detail here) for attaching the seal body to the front wall.

In addition to an above-described seal configuration having a seal body, according to a further embodiment, an air-conditioning module is provided having an above-described two-component seal body preinstalled on air-conditioning or heating pipes. Such an air-conditioning module can already be provided, ready for installation, with a seal body according to the invention by an automobile supplier and can be supplied as a correspondingly preconfigured module for the final installation in the motor vehicle. For the final installation, only pressing or fastening the seal body in another way in the area of the passage opening on the front wall side is to be provided.

According to a further embodiment, a motor vehicle is equipped with the above-described seal configuration.

Further goals, features, and advantageous embodiments are explained in the following description of an exemplary embodiment on the basis of the drawings. All features that are described in the text and also shown in the figures form the subject matter of the present invention both alone and also in any reasonable combination with one another.

### BRIEF DESCRIPTION OF THE DRAWINGS

The present invention will hereinafter be described in conjunction with the following drawing figures, wherein like numerals denote like elements, and:

FIG. 1 shows a perspective view of the seal configuration according to an embodiment that is viewed from the engine compartment of the vehicle; and

FIG. 2 shows a cross-section along section line A-A according to FIG. 1.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

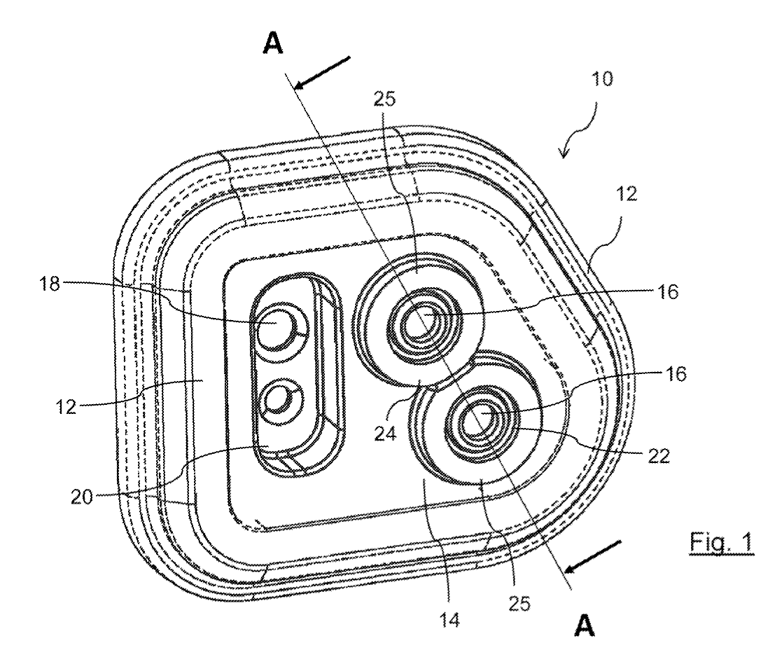

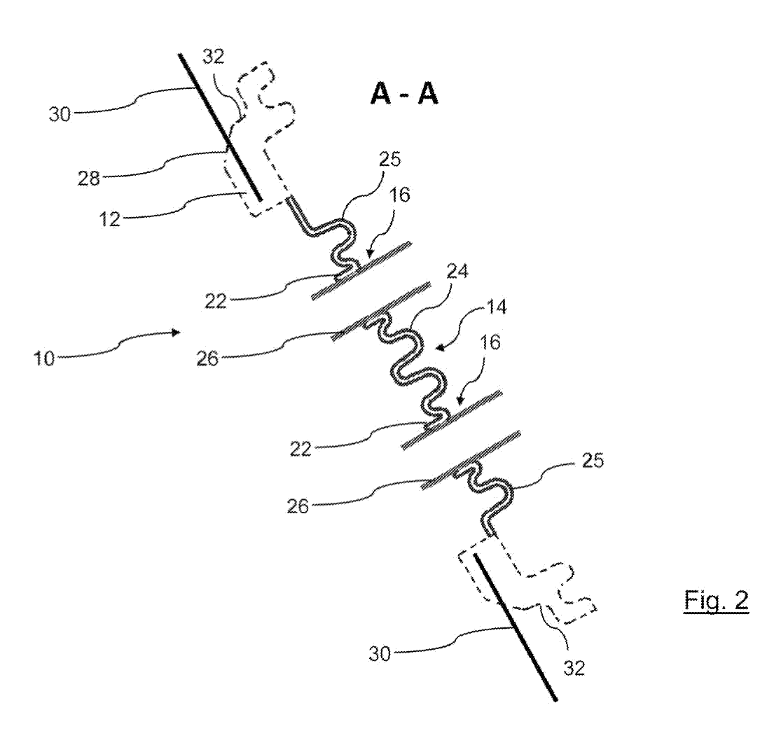

The two-component seal body 10 that is schematically shown in FIG. 1 and FIG. 2 has an outer peripheral seal component 12 and an inner seal component 14 enclosed thereby. Outer and inner seal components 12, 14 differ with respect to their material composition. The inner seal component 14 is manufactured, for example, completely from a natural or synthetic rubber material, for example, from EPDM, which is distinguished by a comparatively high flexibility and elasticity in comparison to the outer seal component 14, which is preferably formed from PUR foam.

Using the outer seal component 12, which is preferably formed from PUR foam, the entire seal body 10 is fastened on the front wall 30 (only schematically indicated in FIG. 2) of the motor vehicle. The fastening of the seal body 10 can be performed by a clamp fit of the outer seal component 12. In this way, a final installation of the seal body 10 on the motor vehicle is conceivable even without the aid of a tool. The outer seal component 12 thus has a pedestal section 32, using which it can be supported on the edge of the passage opening of the front wall upon reaching its final installation position. The outer seal component 12 has a beveled edge or an inclined surface 28 on the radial exterior, using which the outer seal component 12 and, with it, the entire seal body 10 can be pressed or clamped into the passage opening provided on the front wall 30. The outer seal component 12 formed from PUR foam provides the seal body 10 with comparatively good noise installation and provides extensive acoustic decoupling of front wall 30 and inner seal component 14.

As shown in FIG. 1, all passage openings 16, 18 for heating or air-conditioning pipes are formed in the area of the inner seal component 14. As is obvious on the basis of the cross-section according to FIG. 2, the inwardly directed edges of the passage openings 16, 18 are provided with a seal flange section 22, which provides an enlarged seal and mutual contact surface of inner seal component 14 and the pipes 26 guided through the respective openings 16, 18. The axial extension of the flange section 22 preferably corresponds to half to one and one-half times the radius of the respective passage opening 16, 18.

The inner seal component 14 has bulges 24, 25 like folded bellows radially adjoining the opening 16, 18 on the outside, which allow a tolerance-compensating displacement of the passage openings 16, 18 relative to one another, but also in their entirety relative to the outer seal component 12 or to the passage opening of the front wall 30. The reference numeral 25 identifies a bulge extending between the passage opening 16 and the outer edge of the inner seal component 14, while a bulge 24, which comes to rest between adjacent passage openings, is identified by 24. The bulges 24 and 25 are formed in one piece in the present example and respectively represent internal and external sections of a folded bellows formation which completely encompasses the opening.

As may further be seen on the basis of FIG. 1, the passage openings 18 of the inner seal component 14, which are provided for the air-conditioning pipes, are situated in the base area of a trough-like depression 20. The trough 20 is used, for example, for accommodating an expansion valve (not shown in the figures) of the air-conditioning system, which is situated on the side of the engine compartment.

In an installation aspect, the entire seal body 10 can therefore be pushed onto the air-conditioning lines or onto the corresponding heating pipes 26 already before a final installation in the motor vehicle, the expansion valve being able to provide an axial fixation of the seal body 10 in relation to the diverse pipes 26. The position of the seal body 10 relative to the air-conditioning or heating pipes 26 can thus be produced with high precision already before installation of the air-conditioning module on the motor vehicle, which can further simplify the installation of the air-conditioning module.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A seal configuration for sealing an opening of a motor vehicle front wall provided for a plurality of passages for a plurality of conditioning pipes, comprising:
a plurality of openings for the plurality of conditioning pipes;
a two-component seal body adapted for insertion into at least one of the plurality of openings;
a first seal material having a first property and at least partially forming an outer seal component of the two-component seal body; and
a second seal material at least partially forming an inner seal component, the second seal material having a second property that is different from the first property.

2. The seal configuration according to claim 1, wherein the first property is a first moduli of elasticity and the second property is a second moduli of elasticity.

3. The seal configuration according to claim 1, wherein the first property is a first acoustic damping property and the second property is a second acoustic damping property.

4. The seal configuration according to claim 1, wherein the inner seal component is completely enclosed by the outer seal component with respect to an extension of a pipe to be led through the opening.

5. The seal configuration according claim 1, wherein the inner seal component is provided for all of the plurality of openings.

6. The seal configuration according to claim 1, wherein the outer seal component and the inner seal components essentially lie in a common plane.

7. The seal configuration according to claim 1, wherein the inner seal component comprises a peripheral seal flange section on at least one of the plurality of openings.

8. The seal configuration according to claim 1, wherein the inner seal component is at least regionally implemented as a folded bellows in an area of at least one of the plurality of openings.

9. The seal configuration according to claim 1, further comprising a folded bellows connecting the inner seal component to the outer seal component.

10. The seal configuration according to claim 1, wherein the inner seal component is at least partially formed of a natural rubber material.

11. The seal configuration according to claim 1, wherein the inner seal component is at least partially formed of a synthetic rubber material.

12. The seal configuration according to claim 1, wherein the inner seal component is at least partially formed from EPDM.

13. The seal configuration according to claim 1, wherein the outer seal component is at least partially formed from a foamed plastic.

14. The seal configuration according to claim 1, wherein the outer seal component is at least partially formed from an artificial resin.

15. The seal configuration according to claim 1, wherein the outer seal component is at least partially formed from polyurethane.

16. The seal configuration according to claim 1, wherein the outer seal component is connected to the inner seal component in a formfitting manner.

17. The seal configuration according to claim 1, wherein the outer seal component is connected to the inner seal component in a materially bonded manner.

18. The seal configuration according to claim 1, wherein the two-component seal body is fastenable in a friction-locked manner in at least one of the plurality of openings via the outer seal component.

19. The seal configuration according to claim 1, wherein the inner seal component has a trough-like depression for an expansion valve.

20. The seal configuration according to claim 19, wherein the plurality of openings are situated in an area of a base of the trough-like depression.
